(19) United States
(12) Patent Application Publication
(10) Pub. No.: US 2007/0146965 A1
(43) Pub. Date: Jun. 28, 2007

(54) Ultracapacitor pressure control system

(76) Inventors: Porter Mitchell, San Diego, CA (US); Robert Crawford, Murrieta, CA (US); Xiaomei Xi, Carlsbad, CA (US); Linda Zhong, San Diego, CA (US)

Correspondence Address: HENSLEY KIM & EDGINGTON, LLC, 1660 LINCOLN STREET, SUITE 3050, DENVER, CO, 80264-3103, US

(21) Appl. No.: 11/603,534

(22) Filed: Nov. 22, 2006

Related U.S. Application Data
(60) Provisional application No. 60/739,203, filed on Nov. 22, 2005.
(60) Provisional application No. 60/748,897, filed on Dec. 8, 2005.

(51) Int. Cl. H01G 9/00

(52) U.S. Cl. 361/502

(57) ABSTRACT

An ultracapacitor design minimizes the internal pressure of the cell package by using gas getters, either alone or in combination with a resealable vent in the package. Reducing pressure extends the life of the ultracapacitor. The primary gas types generated within a particular ultracapacitor are measured under multiple possible application conditions. Such conditions may include variables of temperature, application voltage, electrolyte type, length of use, and cycles of use. The primary gas components may be determined and suitable gas getters for different conditions may be formulated. The gas getters may be packed within the ultracapacitor packages, formulated as a negative electrode, doped into the negative current collector, or layered with the negative current collector.

### CROSS REFERENCE TO RELATED APPLICATIONS

This application claims the benefit of priority pursuant to 35 U.S.C. § 119(e) of U.S. provisional application Nos. 60/739,203 filed 22 Nov. 2005 entitled “Resealable vent for capacitors” and 60/748,897 filed 8 Dec. 2005 entitled “Minimizing internal pressure by gas getter for high voltage ultracapacitor,” which are hereby incorporated herein by reference in their entirety.

### BACKGROUND

1. Technical Field

The subject matter described herein relates to methods for reduction of pressure due to gas build-up in ultracapacitors.

2. Description of the Related Art

During high voltage charge of an ultracapacitor, particularly in combination with high temperatures, gases are generated due to thermal evaporation, chemical reactions, and electrochemical reactions. The gas generated is trapped within the capacitor packaging. The trapped gas causes the internal pressure of the capacitor to rise, eventually causing the cell package to rupture. Some capacitor packaging often incorporates a one-time use only pressure relief fuse in the wall of the cell container that opens when pressure within the cell exceeds a predetermined design limit. Once the cell package or fuse ruptures, the ultracapacitor is no longer functional. For this reason, ultracapacitors are often limited to certain application voltages, for example, 1.0V for aqueous electrolyte cells and 2.3 to 2.5V for organic solvent electrolyte cells.

In order to achieve increased application voltage, and thus increased energy and power density of ultracapacitors, gas release valves have been incorporated into the packaging to forestall package rupture. This allows the capacitors to operate at higher voltages. However, once the valve opens, solvent vapor and salts from the chemical reactions may crystallize and hold the vent open. If the vent is stuck open, water vapor may enter the cell and poison the electrolyte, thus reducing the voltage and life of the cell. Further, the gas is released into the working environment without any control. In many cases, the gases released may be harmful to humans or animals or may present a risk of fire or explosion.

The information included in this Background section of the specification, including any references cited herein and any description or discussion thereof, is included for technical reference purposes only and is not to be regarded subject matter by which the scope of the invention is to be bound.

### SUMMARY

The technology described herein is an ultracapacitor design that minimizes the internal pressure of the cell package by using gas getters, either alone or in combination with a resealable vent in the package. The primary gas types generated within a particular ultracapacitor are measured under multiple possible application conditions. Such conditions may include variables of temperature, application voltage, electrolyte type, length of use, and cycles of use. The primary gas components may be determined and suitable gas getters for different conditions may be formulated. The gas getters may be packed within the ultracapacitor packages, formulated as a negative electrode, doped into the negative current collector, or layered with the negative current collector.

A resealable vent may additionally be used to reduce gas pressure in a cell and direct the gas to a gas getter for collection. The cell may be one of several cells in a module. The gas getter may be placed in the module in order to capture the gas released through the vents in each of the cells in the module. The module may or may not be hermetically sealed depending upon the type of gas getter formulation used and whether the gas getter is resistant to atmospheric gasses and moisture. The vents may incorporate either a spring or an elastomeric or resilient material, which depresses or deforms under pressure to expose a vent hole, thus allowing the gas to escape. After the pressure is reduced, the spring, elastomer, or other resilient material returns to a low pressure dimensional state and the package is again sealed. As a safety measure, a pressure relief fuse may further be incorporated into the package in the event of failure of the vent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is an isometric view of an ultracapacitor incorporating a gas getter and a gas vent.

FIG. 2 is a schematic diagram of a double layer, jelly roll ultracapacitor sheet windings incorporating a gas getter.

FIG. 3 is a schematic diagram of various layers of sheets in a double-layer ultracapacitor with the negative current collector doped with gas getter material.

FIG. 4 is an isometric view in partial cross section of an ultracapacitor incorporating a vent and a gas getter.

FIG. 5 is an exploded view of the primary parts of a vent for an ultracapacitor.

FIG. 6A-6C are plan views in cross section of the vent in a closed state, a pressurized state, and an open state, respectively.

FIG. 7A is an isometric view of another embodiment of an ultracapacitor with an offset vent.

FIG. 7B is a cross-sectional plan view of the ultracapacitor of FIG. 7A further depicting an incorporated gas getter.

FIG. 8A is an isometric view of a sealed ultracapacitor module.

FIG. 8B is a plan view in cross section of the ultracapacitor module of FIG. 8A further incorporating gas getter material.

### DETAILED DESCRIPTION

Capacitors store energy in an electric field between a pair of closely spaced conductors (called “plates”). When voltage is applied to the capacitor, electric charges of equal magnitude, but opposite polarity, build up on each plate and thereby store energy. “Double-layer” capacitors store electrostatic energy across an electrical potential formed between sheets of electrode films and associated collecting plates immersed in an electrolyte. A polarized electrode-electrolyte interface layer is created when a finished capacitor cell is immersed in the electrolyte. When the sheets are immersed in the electrolyte, a first layer of electrolyte dipole and a second layer of charged species is formed. Double-layer capacitor technology is also referred to as “ultracapacitor” technology and “supercapacitor” technology. Such double-layer capacitors can be obtained from Maxwell Technologies, Inc., (San Diego Calif.).

In comparison to conventional capacitors, double-layer capacitors have high capacitance in relation to their volume and weight. There are two main reasons for these volumetric and weight efficiencies. First, the charge separation layers are very narrow; their widths are typically on the order of nanometers. Second, the electrodes can be made from a porous material, having very large effective surface area per unit volume. Because capacitance is directly proportional to the electrode area and inversely proportional to the widths of the charge separation layers, the combined effect of the large effective surface area and narrow charge separation layers is capacitance that is very high in comparison to that of conventional capacitors of similar size and weight. The high capacitance of double-layer capacitors allows the capacitors to receive, store, and release large amounts of electrical energy.

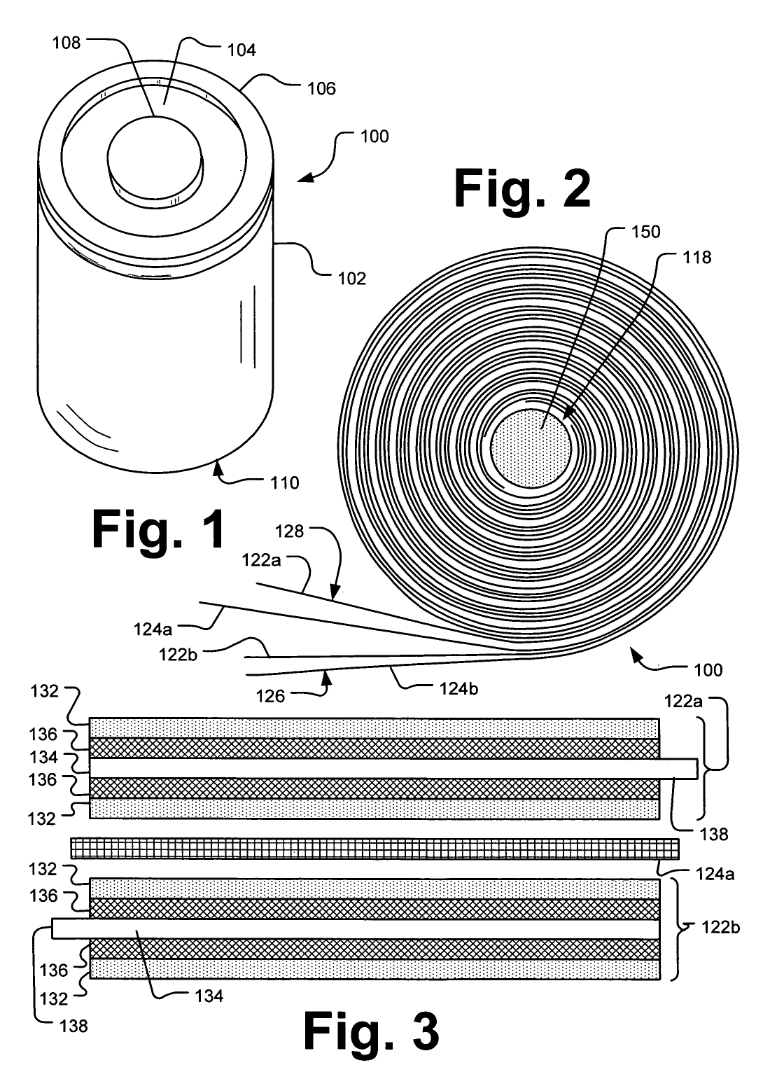

An exemplary ultracapacitor 100 incorporating technological improvements disclosed herein is depicted in FIG. 1. The cell of the ultracapacitor 100 is encased in a container 102 and covered by a cap 104. The container 102 of the ultracapacitor 100 is generally composed of aluminum and may be similar in form to a battery cell. The cap 104 may similarly be made of aluminum or other materials (e.g., an electrically insulating, non-porous plastic material, such as nylon) depending upon other aspects of the configuration of the ultracapacitor 100. The cap 104 may be secured to the container 102 along a crimped rim 106 of the container 102 about the edge of the cap 104 to form a hermetic seal. A gasket or other sealing material (not shown) may be interposed between the edge of the container 102 and the cap 104 along the interface of the crimped rim 106 in order to aid in creating the hermetic seal.

A venting terminal 108 may be provided in the cap 104 that may act both as a terminal for coupling the ultracapacitor to a lead and as a vent to exhaust gases that may form and build up within the container 102 during charge and discharge cycles of the ultracapacitor 100. In alternate embodiments, a venting structure may be provided separately from the terminal. Further, the ultracapacitor may have two terminals in the cap, rather than using the base 110 of the housing as a terminal as in FIG. 1. In another embodiment, the entire cap 104 may function as the terminal. Additionally, in the implementation shown in FIG. 1, the venting terminal 108 may further function as an electrolyte port for introducing electrolyte into the cell within the container 102. Exemplary forms of vents for use in an ultracapacitor container are described further below.

An exemplary cell structure 120 of the ultracapacitor 100 enclosed within the container 102 is shown schematically in FIG. 2. The double-layer cell 120 may be formed as a spiral winding of electrode sheets and insulating sheets. The double-layer cell 120 may be composed of a first plate sheet 122a and a second plate sheet 122b separated by a porous separator sheet 124a. A second porous separator sheet 124b may placed adjacent to and outer face 126 of the second plate sheet 122b to insulate the second plate sheet 122b from an outer face 128 of the first plate sheet 122a when the plate sheets 122a, 122b are rolled together to form the spiral cell 120. The resulting geometry of the capacitor cell 120 is generally known as a “jelly-roll.”

Note that a cylindrical void 118 is formed in the center of the spiral shell 120. In one implementation discussed in greater detail below, a gas getter material 150 may be inserted within the cylindrical void 118 at the time of manufacture of the capacitor 100 in order to absorb the primary gases emitted by the chemical and electrochemical reactions that occur within the container 102 upon addition of the electrolyte and charge and discharge of the ultracapacitor 100. As indicated above, pressure build-up due to gas formation in the sealed container 102 can rupture the container 102 and disable the capacitor 100.

In FIG. 3, the first plate sheet 122a and the second plate sheet 122b are each shown in cross section along with on of the porous separator sheets 124a. Each of the plate sheets 122a, 122b comprises two electrode films 132 and a current collector sheet 134. The current collector sheets 134 in each of the plate sheets 122a, 122b may be wider than the other components such that one of the ends 138 if the current collector sheets 134 extends beyond the edges of the electrode films 132. The ends 138 of the current collector sheets 134 may thus be electrically coupled with terminal connections of the ultracapacitor 100.

The interior surfaces of the electrode films 132 may be electrically and physically coupled with the current collector sheet 134. In one embodiment, the electrode films 132 may be bonded to the current collector sheet 134 by a respective conductive adhesive layer 136. However, an adhesive bond layer may not be required in all applications.

In one embodiment, the electrode films 132 may be formed from a blend primarily of activated carbon particles and a binder material. Optionally, a small amount of conductive carbon particles with low contamination level and high conductivity may be introduced into the blend. In various implementations, the blend may be about 80 to about 97 percent by weight of activated carbon with about 3 to about 20 percent by weight of PTFE. Conductive carbon may optionally be added in a range of about 0 to about 17 percent by weight. One or more of a variety of binders may be used including polytetraflouroethylene (PTFE) in granular powder form, one or more of various other fluoropolymer particles, polypropylene, polyethylene, co-polymers, and/or other polymer blends.

In a further embodiment wherein the capacitor 100 is polarized, one of the electrode films 134 that will form the negative electrode may be doped with a gas getter material as further described below in order to absorb gases created by the chemical and electrochemical reactions occurring within the capacitor. Doping should be limited to the negative electrode. Gas gettering concepts are described in greater detail herein below.

The current collector sheet may be a sheet of aluminum or other conductor that will not chemically interact with the electrolyte solution within the container 102. The aluminum sheets may be etched, roughened, or grooved to increase the contact area between the electrode film and the current collector.

As indicated above, the first and second plate sheets 122a, 122b and first and second separator sheets 124a, 124b may be rolled together. The first and second plate sheets 122a, 122b may be rolled together in an offset manner that allows the exposed end 138 of the collector sheet 134 of the first plate sheet 122a to extend in one direction and the exposed end 138 of the collector sheet 134 of the second plate sheet 122b to extend in a second direction. In this way, opposing terminals of the capacitor 100 may be located on opposite ends, e.g., the cap 104 and base 110, of the capacitor 100.

As noted above, the electrode films 132 are typically immersed in an electrolyte (an electrolytic solution) to provide the energy storage for double-layer capacitors. Electrolytes currently used in double-layer capacitors are of two kinds. The first kind includes aqueous electrolytic solutions, for example, potassium hydroxide and sulfuric acid solutions. Double-layer capacitors may also be made with organic electrolytes, for example, 1.5 M tetramethylammonium tetrafluroborate in organic solutions such as propylene carbonate (PC) solution and acetonitrile (AN) solution. The electrolyte may also be composed of liquid salts, commonly referred to as ionic liquids, certain liquid crystal electrolytes, and even solid electrolytes.

The porous separator sheets 124a, 124b may be at least partially immersed in and impregnated with the electrolyte. The porous separator sheets 124a, 124b may also ensure that the electrode films 132 do not come in contact with each other, preventing electronic current flow directly between the electrode films. At the same time, the porous separator allows ionic currents to flow through the electrolyte between the electrode sheets in both directions. The porous separator sheets 124a, 124b may be made of one or more ceramics, paper, polymers, polymer fibers, or glass fibers. The porous separator sheets further provide a wicking action to distribute the electrolyte throughout the cell. Double layers of charges are formed at the interfaces between the electrode sheets and the electrolyte.

When electric potential is applied between a pair of electrodes of a double-layer capacitor, ions that exist within the electrolyte are attracted to the surfaces of the oppositely charged electrode films 132, and migrate towards the electrode films 132. A layer of oppositely charged ions is thus created and maintained near each surface of the electrode films 132. Electrical energy is stored as potential across the charge separation layers (i.e., the porous separation sheets 124a, 124b) between these ionic layers (within the electrolyte) and the charge layers of the corresponding electrode surfaces. In fact, the charge separation layers behave essentially as electrostatic capacitors. Electrostatic energy can also be stored in the double-layer capacitors through orientation and alignment of molecules of the electrolytic solution under influence of the electric field induced by the potential. This mode of energy storage, however, is secondary.

In one embodiment, the current collector sheets 134 may comprise an etched or roughened aluminum foil of about 30 microns in thickness, the adhesive layers 136 may comprise a thickness of about 5 to 15 microns, the electrode films 132 may comprise a thickness of about 80 to 250 microns, and the paper separator sheets 124a, 124b may comprise a thickness of about 20-30 microns. Double-layer capacitors generally have intrinsic properties that limit their maximum charging voltage to a theoretical value of no more than about 4.0 volts. In one embodiment, a nominal maximum charging voltage of a double-layer capacitor is in a range of about 2.5 to 3.0 volts.

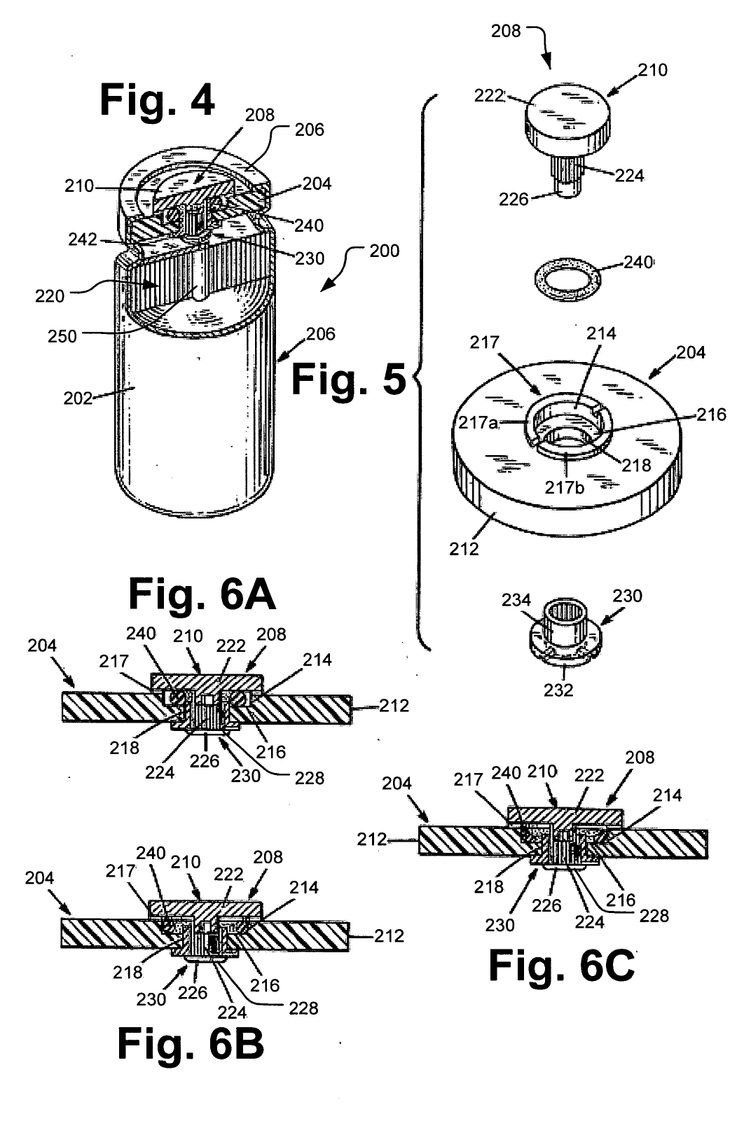

As described above in reference to FIG. 1, the capacitor 100 may include a resealable vent 108 in order to release gas formed within the container 102 before the pressure build-up ruptures the container 102 and disables the capacitor 100. In FIG. 1, the resealable vent 108 also functions as a terminal. An exemplary implementation of a resealable terminal vent 208 for an ultracapacitor 200 is depicted in greater detail in FIGS. 4-6C. As shown in FIG. 4, the resealable vent 208 may be mounted on the cap 204 at the top end of the container 204, which forms an enclosure for the capacitor cell 220 housed therein. The cap 204 may be a cylindrical body having an outer periphery 212 for sealing engagement with the side and end walls of container 202. The top end wall of the container 202 may be crimped in a rim 206 about the periphery 212 of the cap 204 to form a gas-tight seal.

As shown in FIGS. 4 and 5, the vent 208 may comprise a combination of components including the cap 204, a rivet 210, and a grommet 230. The cap 204 may be described as a thin cylinder or disk-shaped body 212 defining a recess 214 at its center having a flat bottom wall 216. A hole 218 is defined in the center of the bottom wall of the recess 214 passing through the body 212. An O-ring 240 of a diameter slightly greater than the depth of the recess 214 in a relaxed state seats on the flat bottom wall 216 of the recess 214 around the hole 218. The center of the body 212 around the recess 214 may be a raised annular wall 217 broken in half by two grooves 217a, 217b, which assist in the venting of gas from within the container 202 as further described below.

The rivet 210 may have a head 222 and a shank 224 with a reduced shank end 226. The shank 224 passes through the hole 218 in the body 212 of the cap 204. The head 222 of the rivet 210 may be slightly larger in diameter than the diameter of the recess 214 and seats on the O-ring 240 and the annular wall 217 to cover and seal the recess 214.

The grommet 230 may be formed of metal with a flat, washer-like portion 232 and an upwardly extending sleeve portion 234. The sleeve portion 234 extends upwardly through the hole 218 in the cylindrical body 212. The sleeve portion 234 of the grommet 230 seats about the outer diameter of the rivet shank 224, between the rivet shank 224 and the sidewall of the hole 218. The upper surface of the washer portion 232 seats flush with the bottom surface of the body 212 of the cap 204.

In order to secure the rivet 210 to the grommet 230, the reduced end 226 of the rivet 210 is outturned to form a flange 228 over the adjoining edge of the outer surface of the washer portion 232 of the grommet 230. The rivet 210 and the grommet 230 are thus held together firmly against the top and bottom surfaces of the cap 204 to form the vent assembly 208. Clearance is provided between the outer diameter of the rivet shank 224 and the inner diameter of the sleeve portion 234 of the grommet 230 in order to allow gas from the canister 202 to migrate into the recess 214. The inner diameter of the sleeve portion 234, the outer diameter of the rivet shank 224, or both may be longitudinally fluted in order to provide channels for gas migration. The bottom surface of the washer portion 232 of the grommet 230 may similarly be radially grooved or fluted to ensure that gas can migrate through the grooves to the space or channels between the inner diameter of the sleeve portion 234 and the rivet shank 224 once the reduced end 226 of the rivet 210 forms the flange seal 228 against the bottom surface of the grommet 230.

As shown in FIGS. 6A, 6B, and 6C, the O-ring 240 is mounted in the recess 214 of the body 212 between the under surface of the head 222 of the rivet 220 and the bottom wall 216 of the recess 214. The O-ring 240 may be composed of a temperature resistant, resilient material, such as neoprene, and in its normal, relaxed position, surrounds the shank 224 of the rivet 220 between the under surface of the rivet head 222 and the bottom wall 216, forming a gas-tight seal therebetween.

In one embodiment, the rivet 210 may be conductive and the flange 228 of the rivet 210 may be connected, e.g., by laser welding, to a current collector 242 attached to the current collector sheet extending from the top of the capacitor cell. Thus, the resealable vent 208 may also operate as a terminal for the ultracapacitor 200.

As shown in FIG. 6A, during normal operation of the ultracapacitor 200, when pressure within the canister 202 is normal, the O-ring 240 is relaxed, contracted, and compressed between the under surface of the rivet head 222 and the bottom wall 216 of the recess 214. In this configuration, the vent 208 is closed. When gas pressure within the canister increases, such increased pressure is applied to the O-ring 240 through the clearance between the rivet 210 and the grommet 230. The increase in pressure forces the O-ring 240 outwardly in the recess 214, away from the shank 224 of the rivet 210, thereby stretching the O-ring and decreasing the cross section or thickness of the O-ring 240 as shown in FIG. 6B. The decrease in cross section or thickness in the O-ring 240 increases as the pressure increases and O-ring 240 expands.

Ultimately, the decrease in the thickness of the O-ring 240 provides a clearance between the head 222 of the rivet 210 and the bottom wall 216 of the recess 214, venting gases from the ultracapacitor cell as shown in FIG. 6C. Once the gas is sufficiently vented to reduce the pressure and pressure within the cell returns to normal, or otherwise below a venting threshold based upon the expansion properties of the O-ring 240, the O-ring 40 contracts, re-closing the vent 208 until such time as the gas pressure increases to force the vent 208 open.

While use of a resealable vent in an ultracapacitor may be helpful to control the pressure build-up within an ultracapacitor due to the creation of byproduct gases, venting of gases may not always be desirable. For example, hydrogen (H₂) is often a primary constituent of the gas generated in an ultracapacitor. Hydrogen is highly combustible. Depending upon the environment in which the capacitor operates and the additional venting within the environment, safety considerations may counsel against venting the gas. For example, ultracapacitors are often used to store energy within hybrid automobiles. However, such vehicles still incorporate a combustion engine, which could also spark the combustion of a release of hydrogen gas outside the confines of the engine block.

Another possible drawback to the use of a vent in an ultracapacitor in all situations is the possibility that the vent may become stuck in an open position during the initial release of pressure. This possibility may occur because the gas released often includes salts that may crystallize at the vent opening and prevent the vent from closing once the pressure is reduced. If the vent remains open, water vapor may enter the cell and poison the electrolyte, which is often an inorganic material. If the electrolyte becomes contaminated, the cell life will actually become shortened and the performance of the cell for the rest of the cell life will be diminished.

As depicted in FIGS. 2 and 4, a gas getter 150, 250, respectively, may be positioned within the canister of the ultracapacitor in order to absorb the gas generated and thus extend the life of the ultracapacitor. The gas getter material may be used in lieu of or in addition to the vent system described above and elsewhere herein. Materials referred to as getters, degassers, absorbers, or scavengers have the capability to chemically bind the gases within themselves rather than by physical surface adsorption. A detailed discussion of gas getters and uses therefore, primarily in the transportation industry, may be found in Nigrey, P. J., An issue paper on the use of hydrogen getters in transportation packaging (Sandia National Laboratories, February 2000), which is hereby incorporated herein by reference in its entirety.

The chemical bonds formed during the reaction of the gas with the getter material may vary in strength. In situations where chemical reactions have occurred during the gas adsorption process, i.e., where the getter material is transformed from the original composition to a new composition, strong chemical bonds are typically formed, and the getter is referred to as an irreversible getter. When the adsorbate gas forms a weakly bonded complex with the getter material, the getter is referred to as a reversible getter. The distinction between these getter materials is that reversible getters, upon the appropriate physical treatment, will revert to their original composition, allowing them to be regenerated and reused.

The regeneration in all cases is accomplished by supplying sufficient thermal energy (heating) to decompose the weakly bonded getter/adsorbate complex. For example, with reversible getters, gaseous adsorbates such as water vapor, carbon dioxide, nitrogen, and hydrogen and its isotopes form hydrates, carbonates, nitrides, and hydride (deuteride or tritide) compositions. Because both reversible and irreversible getters consume the gaseous species to form a new solid composition, the net process in sealed systems is a reduction in the partial pressure.

The accumulation of hydrogen is usually an undesirable occurrence because hydrogen buildup in sealed systems poses explosion hazards under certain conditions. Hydrogen scavengers, or getters, can avert these problems by removing hydrogen from these environments. Hydrogen and its isotopes can react with various chemical compounds to form hydrogen-rich chemical compounds, and when such compounds are formed with metals, they are referred to as metal hydrides. Alternatively, chemical compounds that contain unsaturated carbon-carbon bonds, such as alkenes (carbon-carbon double bonds) and alkynes (carbon-carbon triple bonds), as part of their chemical composition can form saturated carbon-carbon bonds or alkanes (carbon-carbon single bonds) when catalytically reacted with hydrogen.

Such reactions, however, are not spontaneous at ambient temperature and pressure in the absence of a catalyst. Typically, such reactions only occur in significant rates at elevated temperatures (>100° C.), high pressures (>100 atmospheres), and in the presence of specific catalysts. These hydrogenation catalysts include the previously mentioned metal hydrides as the catalytic intermediate. The most prominent metal hydrides used in such reactions are precious-metal hydrides such as ruthenium, rhodium, and palladium hydride. However, most of these catalytic reactions are homogeneous in nature, i.e., the hydrogenation reactions occur in solution. Heterogeneous catalysis (catalysis occurring at the solid/gas interface) reactions form the basis of all hydrogen getter materials response, whether they are reversible or irreversible. The efficient usage of getters relies on materials that exhibit high hydrogen-to-metal ratios with complete reversibility of hydrogen adsorption/desorption at relatively low temperatures. Another selection criterion for getters is the potential poisoning effect on getter materials of specific small molecular species.

The getter scavenges hydrogen in a chemical reaction, and all chemical reactions are driven by a combination of thermodynamic and kinetic factors. The component that drives the speed of a reaction produces the kinetics of that reaction. Kinetics of chemical reactions usually exhibit Arrhenius behavior, i.e., they are activated by temperature. With increased temperature, increased reaction rates are typically observed. Depending on the type of getter material involved, there exists an optimum temperature range for optimum getter performance. In the case of reversible getter materials, that optimum temperature range usually spans several hundred degreed centigrade, while the irreversible getters are restricted to temperatures near 100° C. Since the optimum hydrogen gettering temperature is dependent on the specific material, it is not possible to be more specific here.

It should be noted, however, that the optimum temperature is determined by the decomposition temperature of the getter/adsorbate complex. For reversible metal hydride getters, the decomposition temperature of the metal hydride provides some indication of the maximum temperature at which these materials can be used without significantly decreasing gettering performance. For these materials, decomposition temperatures in excess of 500° C. are typical. For irreversible systems involving organic compounds, decomposition temperatures are usually more than 150° C. The explanation for these relatively low decomposition temperatures is that virtually all organic compounds undergo some thermal degradation at temperatures approaching 200° C. If expected temperatures are considerably below 150° C., irreversible getters may be appropriate. The opposite is certainly required when normal conditions exceed that temperature.

One all-metallic, air-operable, composite getter for hydrogen (available from Pacific Northwest National Laboratories) can getter hydrogen in air or an inert atmosphere at ambient or elevated temperatures. The composite getter design is an all-metal, coated zirconium-based getter, with the metal coating providing a protective oxygen barrier while simultaneously allowing transport of hydrogen. A specific deposition method with specific parameters is used to lay down the protective metal layer of specific thickness. The coating minimizes passivation of the getter in air, oxygen, or moisture. The getter is shown to work in air at ambient temperature to 150-200° C. The measured hydrogen gettering rate, based on present data to date, ranges from 25-50 cc STP/day/kg (0.025-0.050 cc STP/day/g) of getter directly in air. In inert atmosphere, the rate is higher by a factor of 1000. The hydrogen loading capacity of the getter is measured at 160 liters STP/kg (O.160 liters STP/g) of getter, regardless of atmosphere. With the coated two-piece getter design, potential contaminating gases, such as halogenated volatile organic hydrocarbons, carbon monoxide, or moisture, may not affect getter kinetics or capacity, since the atmosphere never comes in contact with the actual getter surface.

Lanthanum pentanickel is a lanthanum-nickel alloy representing a class of AB₅-type materials. Magnesium and magnesium alloys are extremely attractive as hydrogen getters because they can store more hydrogen by weight (3.6%) than most metal hydrides.

Another possible getter is similar to a manganese oxide/silver oxide getter and comprises a combination of three different active getter materials integrated in a single construct. A cobalt oxide provides an efficient sorption speed and capacity for hydrogen. A calcium oxide component is a highly efficient dessicant that intercepts and adsorbs moisture. Further, a barium-lithium alloy adsorbs nitrogen and other active gases such as oxygen and carbon dioxide. In addition, these three component materials adsorb gases at room temperature. Short air exposure (e.g., up to 15 minutes) may not affect the getter's adsorption characteristics. One advantage of this type of a gettering system is the removal of potential poisons to the active hydrogen gettering material, cobalt oxide.

There may be several criteria that can be used to determine an appropriate getter for a particular ultracapacitor application. These criteria may include the following:

Capacity—Determination of the getter's capacity relative to the potential total gas generated over the desired life span of the ultracapacitor.

Pressure—Determination of the maximum normal operating pressure of the ultracapacitor and whether getter's performance is affected by pressure

Poisons—Determination of whether there any chemical constituents in the contents that could potentially poison the getter.

Reversibility—Determination of what conditions may cause the getter to release hydrogen and whether these conditions could occur for the proposed use or environment.

Temperature—Determination of the effective temperature range of the getter relative to the operating temperature conditions.

Humidity—Determination of the effect of water vapor on the getter.

Location—Determination of any impact of the location of the getter.

Thermal—Determination of whether the getter releases or absorbs heat.

In order to determine the quantity of gas getter to use in a specific ultracapacitor application, the following factors may be considered. First, the quantity of gas developed by the ultracapacitor at the particular voltage and expected temperature of operation should be determined. Second, the quantity of gas absorbed per gram of the gas getter should be determined. Third, the expected or desired lifespan of the ultracapacitor should be determined. The calculation of the amount of getter for use in the ultracapacitor then directly follows.

The following is one particular of the composition of gas generated within a typical ultracapacitor cell using AN as a solvent.

| Gas | Formula | % volume |
|---|---|---|
| Hydrogen | H2 | 40.0 |
| Oxygen | O2 | 6.9 |
| Nitrogen | N2 | 29.8 |
| Methane | CH4 | 1.9 |
| Carbon Monoxide | CO | 4.5 |
| Acetonitrile | CH3CN | 11.7 |
| 1,1,1,trifluoroethane | CH3CF3 | 2.8 |
| Argon/CO2 | Ar/CO2 | |

Note that the N₂ amount was affected due to a N₂ purge before measurement. Using this information with respect to particular electrodes an electrolyte materials, an appropriate gas getter formula may be determined to remove the gases constituting the highest volume of generation.

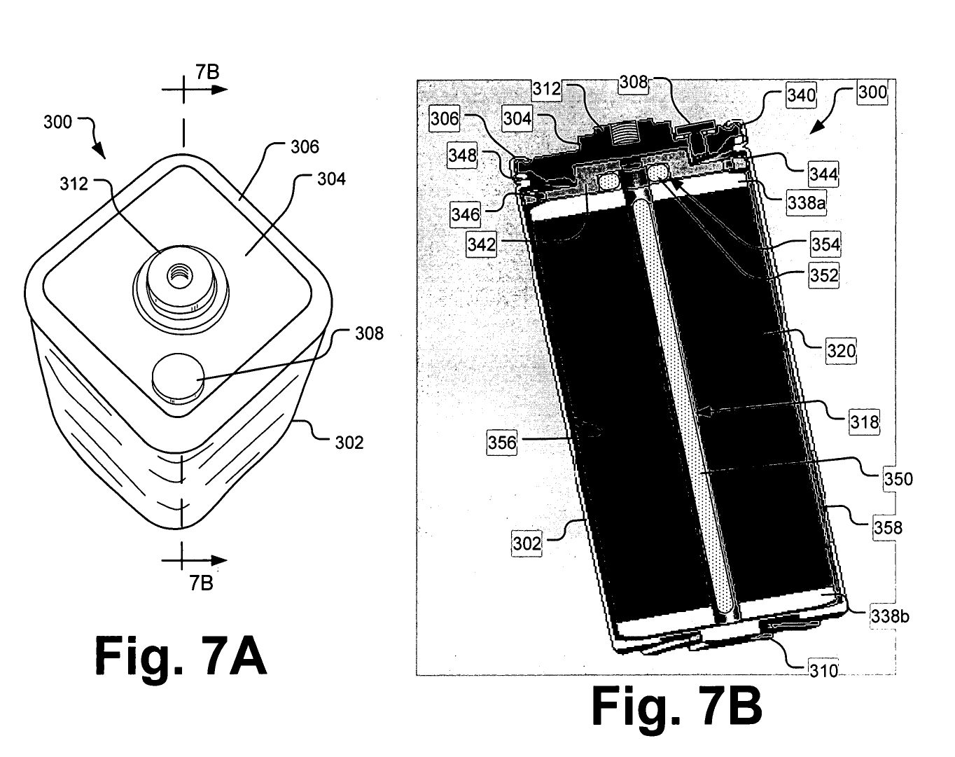

Referring now to FIGS. 7A and 7B, a rolled double-layer ultracapacitor 300 comprising offset collectors (e.g., the current collector sheets 134 as shown in FIG. 3) is housed in a canister 302. During manufacture, a rolled double-layer capacitor cell 320 is inserted into an open end of the canister 302, and electrolyte is added within the canister 302. A current collector 342 may be placed on top of the cell 320 and connected with the exposed edge 338a of the current collector sheet extending above the cell 320. Similarly, the exposed collector edge 338b of the current collector sheet extending below the capacitor cell 320 makes internal contact with the bottom end 310 of the canister 302. An insulating material 344 may be placed about the periphery of the current collector 342 in order to insulate the current collector from the sidewalls of the canister 302.

A cap 304 may be placed on top of the current collector 342. Both the current collector 342 and the cap 302 may be conductive. In one embodiment, the external surface of the cap 304 or external bottom surface 310 of the canister 302 may include or be coupled to standardized connections or connectors, to facilitate electrical connection to the rolled capacitor cell 320 within the canister 302. The external surface of the cap 304 may be formed as a terminal 312 to aid with electrical connections. In other embodiments, the terminal 312 may be a separate component that is affixed to the cap 304. In one embodiment, the terminal 312 may also function as a seal for a port, e.g., as a threaded plug, for the introduction of electrolytic fluid into the cell 320.

An insulator 340 may be placed along the periphery of the cap 304 at the open end of the canister 302. During manufacture, the canister 302, insulator 340, and cap 304 may be mechanically crimped or curled together to form a sealed rim 306 around the periphery, whereby after the curling process, the canister 302 is electrically insulated from the cap 304 by the insulator 330. In one embodiment, a gasket or O-ring 348 may be positioned between a peripheral edge of the cap 304 and the wall of the canister 302 such that when the canister 302 and cap are curled together, the O-ring 348 additionally acts as an insulator and further hermetically seals the canister 302.

A pressure release vent 308 may additionally be located within the cap 304. In the exemplary embodiment of FIGS. 7A and 7B, the vent 308 may be separate and offset from the terminal 312. The vent 308 may be similar in construction to the vent of FIGS. 4-6C, or may be of an alternate construction. In one embodiment, the vent 308 may be inserted into a hole in the cap 304 after the cap 304 is crimped to the canister 302. In this embodiment, the hole for the vent 308 may also be used as a port to fill the canister 302 with electrolyte for the cell 320. Once the electrolyte has filled the canister 302, a vacuum may be drawn and then the resealable vent 308 may be inserted into the hole in the cap 302 to complete the hermetic seal.

Note also, that the canister 302 may be designed to include a safety fuse 358 within a wall of the canister 302. The safety fuse 358 may be formed by scoring or otherwise weakening a small area of the canister 302 (e.g., 1 mm) to ensure that the canister 302 will rupture if the vent 308 fails and the pressure exceeds design limits. A typical maximum pressure within an ultracapacitor at which a safety fuse 358 is designed to fail is approximately 15 bar. A safety fuse 358 in the canister wall may be desirable to avoid the possibility of the cap 304 shooting out of the top of the canister 302 like a projectile.

Note that the use of a resealable vent 308 may be preferable to relying only upon a safety fuse 358 even with the potential problems of a vent 308 as discussed above. For example, even if the vent 308 did get stuck in an open position due to salt build-up or other causes, the capacitor 300 would continue to operate for many more cycles although at diminished capacity. In contrast, if the canister 302 ruptures at the safety fuse 358, the electrolyte in the cell 320 quickly evaporates and the cell 320 ceases to function in a short period of time.

In addition to the resealable vent 308 and the safety fuse 358, the ultracapacitor 300 may further include a gas getter material disposed within the canister 302 or cell 320 at one or more locations in order to extend the life of the ultracapacitor 300. As in prior implementations described above, the gas getter 350 may be in the form of a long, cylindrical package or a composite sized to fit within the cylindrical void 318 of the jelly roll cell 320. In one particular example, a 164 mg of gas getter material was packaged in a high-density polyethylene pouch approximately 30 mm long and 4 mm in diameter for placement within the cylindrical void 318.

In another particular example, 1.4 g of H₂ getter material was packaged in a high-density polyethylene pouch 60 mm long and 4 mm in diameter and placed in the cylindrical void of an ultracapacitor. The H₂ getter material had an absorption rating of 150 Torr-L and was rated for use in air-filled environments at up to 120° C. Electrolyte was added to the canister and the canister was sealed. A delay period of 200 hours after the addition of electrolyte was observed before the ultracapacitor was actuated. The H₂ getter material ultimately and reached a saturation point after 2000 hours of operation at 2.7V and 65° C. The life of the capacitor cell was significantly longer than the lifespan without the gas getter.

In a further particular example, 0.7 g of H₂ getter was packaged high-density polyethylene pouch 43 mm long and 2.8 mm in diameter and placed in the cylindrical void of an ultracapacitor. The void was approximately 43 mm long and 6.5 mm in diameter. The H₂ getter material had an absorption rating of 150 Torr-L and was rated for use in air-filled environments at up to 120° C. Electrolyte was added to the canister and the canister was sealed. A delay period of 200 hours after the addition of electrolyte was observed before the ultracapacitor was actuated. The H₂ getter material ultimately and reached a saturation point after 4000 hours of operation at 2.5V and 65° C. Again, the life of the capacitor cell was significantly longer than the lifespan without the gas getter.

In other embodiments, the current collector 342 may be formed with a pattern of grooves or recesses 354 within which the gas getter material 352 may be packed or otherwise disposed. In yet another embodiment, the gas getter material may be in the form of a coating 356 on the interior walls of the canister 302. By using gas getter materials within the ultracapacitor 300, the life of the ultracapacitor 300 may be significantly extended.

Contact between respective collector extensions 338a, 338b and the internal bottom surface 310 of the canister 302 and the current collector 342 may be enhanced by a welding, soldering, and/or brazing processes. In one embodiment, canister 302, current collector 342, and collector extensions 338a, 338b comprise substantially the same metal, for example, aluminum, a laser welding process may be applied externally through the cap 304 and canister 302. With laser welding, respective internally abutting aluminum collector extensions 338a, 338b are be bonded to the aluminum canister 302 and current collector 342 without the use of additional bonding metal. In some embodiments, the current collector 342 may be perforated or otherwise formed with openings 346 in order to allow for the electrolytic fluid to reach the cell 320 if the electrolytic fluid is added after the current collector 342 is connected to the exposed edges 338a of the current collector sheet 330.

Note that if the canister 302, cap 304, current collector 342, and collector sheets are substantially similar metals and are bonded to each other, a galvanic effect will not be created at the bonding or welding points. This is in contrast to batteries, which are typically subject to the galvanic effect at dissimilar anode and cathode metal connection points. Due in part to the galvanic effect, batteries become polarized, and consequently must be connected through their terminals with a correct positive and negative orientation. In one embodiment, because a double-layer capacitor 300 connected by the laser welding process does not utilize dissimilar metals, such an ultracapacitor would not initially experience a polarizing effect. However, after initial use of the capacitor 300, for example, after its initial charge cycle, the ultracapacitor 300 would become polarized because a positive charge would accumulate at one collector plate and a negative charge would accumulate at another collector plate. Unless such a charged capacitor was to be subsequently completely discharged, the established polarization of the capacitor would need to be considered with continued use.

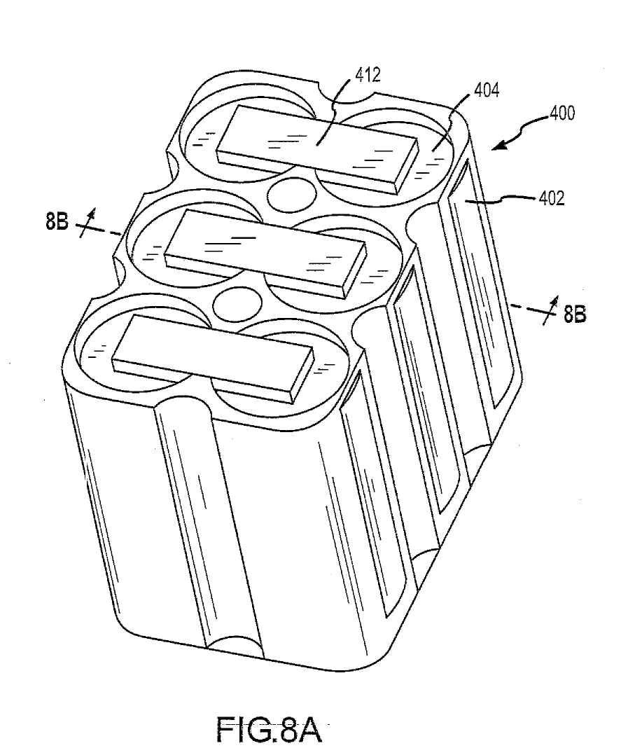

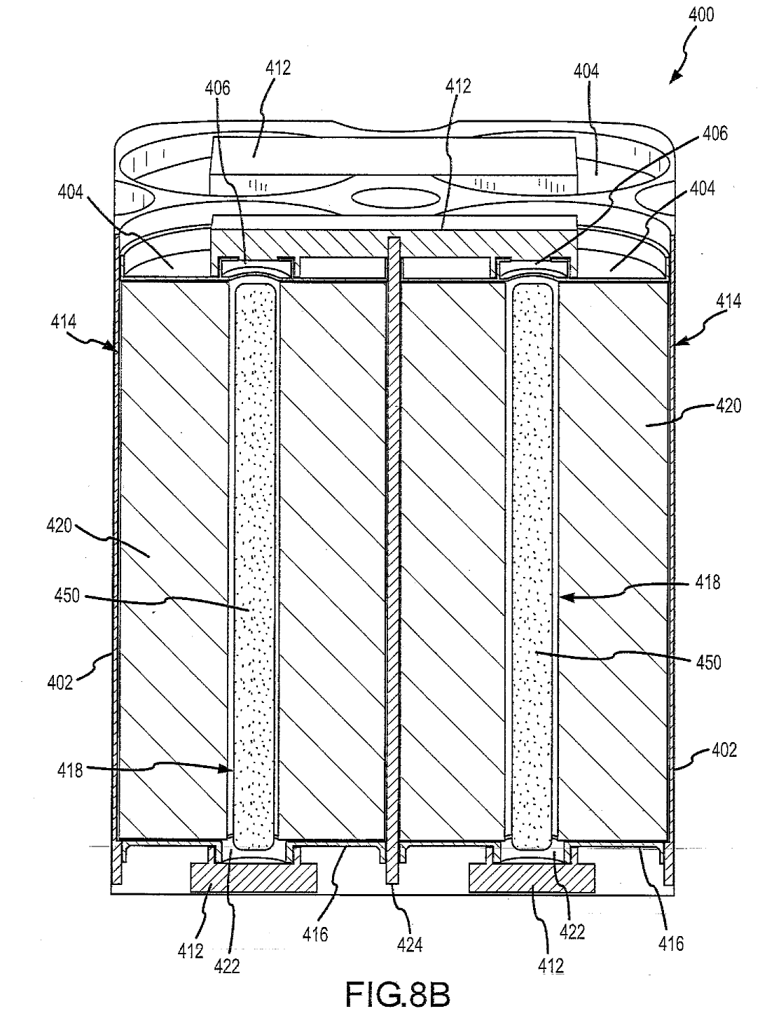

FIGS. 8A and 8B depict an integrated ultracapacitor module 400 defined by an outer housing 402. The module 400 may be a unitary enclosure defining multiple cavities 414, six in this embodiment, within which are housed rolled, double-layer ultracapacitor cells 440. In other forms, the module may be understood as a case within which individual capacitor containers are housed and sealed, generally in series contact. During manufacture, a rolled double-layer capacitor cell 420 may be inserted into each of the openings in the module 400. Electrolyte is also added to the cavities 414.

A current collector cap 404 may be placed on top of the cells 420 in each cavity 414. The current collector caps 404 may be designed to fit tightly within the openings of the cavities 414 to make a hermetic seal. A current collector cap 416 also forms the bottom of each of the cavities 414 in the module 400. The current collector caps 404, 416 make electrical contact with the exposed collector edges of the current collector sheets of the capacitor cell 420. The tops of the current collector caps 404 and the bottoms of the current collector caps 416 may be formed with terminals 406, 422, respectively. The terminals 406, 422 are connected by a set of bar-shaped buses 412. There are three buses 412 on the top of the module arrange in parallel connecting the top terminals 406 of each adjacent pair of cells 420. There are two buses 412 on the bottom of the module 400 oriented perpendicular to the top buses and staggered such that one bus connects only two terminals 412 along one side of the module and two terminals 412 along the other side of the module 400, wherein the middle cells 420 are both connected with a bus, but only one set of diagonal corner cells 420 are connected with a bus. In this configuration, all of the cells 420 are electrically coupled in series.

The ultracapacitor module 400 may further include gas getter material 450 disposed within the housing 302. In one embodiment, the gas getter material 450 may be disposed in each of the cavities 414 at one or more locations in order to extend the life of the ultracapacitor 400. As in prior implementations described above, the gas getter 450 may be in the form of a long, cylindrical package or a composite sized to fit within the cylindrical void 418 of the jelly roll cell 420 in each cavity.

In an alternate embodiment, each of the current collector caps 404 may further comprise a pressure release vent (not shown). The vents may be separate and offset from the terminals 406 and located in such a position as to avoid contact with the related bus. The vents may be similar in construction to the vent of FIGS. 4-6C, or may be of an alternate construction. In one embodiment, the module may include a cover over the housing to seal the gases vented from the cavities from escaping into the environment. In this embodiment, gas getter material may be placed in any void spaces between the cover and the housing.

Although various embodiments of this invention have been described above with a certain degree of particularity, or with reference to one or more individual embodiments, those skilled in the art could make numerous alterations to the disclosed embodiments without departing from the spirit or scope of this invention. All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the basic elements of the invention as defined in the following claims.

What is claimed is:

1. An ultracapacitor comprising
a canister;
a double-layer capacitor cell housed within the canister; and
a gas getter material disposed within the housing.

2. The ultracapacitor of claim 1 further comprising a resealable vent mounted in a wall of the canister that releases gas formed within the canister external to the canister.

3. The ultracapacitor of claim 1, wherein
the capacitor cell is formed as a roll of films and defines a hollow area in the center of the roll; and
the gas getter material is placed within the hollow area.

4. The ultracapacitor of claim 1, wherein
the canister further comprises a cap;
the cap is formed with a recess in an interior surface; and
the getter material is placed within the recess in the cap.

5. The ultracapacitor of claim 1, wherein the gas getter material comprises a passivation layer resistant to moisture and atmospheric gases.

6. The ultracapacitor of claim 1, wherein the gas getter material comprises a coating on an interior surface of the canister.

7. The ultracapacitor of claim 1, wherein the gas getter material is in the form of a composite.

8. The ultracapacitor of claim 1, wherein
the gas getter material is in the form of a powder; and
the ultracapacitor further comprises a gas permeable pouch containing the gas getter material.

9. The ultracapacitor of claim 1, wherein
the capacitor cell comprises a negative current collector; and
the negative current collector comprises the gas getter material.

10. The ultracapacitor of claim 1, wherein the gas getter material comprises a material that absorbs hydrogen.

11. The ultracapacitor of claim 1, wherein the gas getter material comprises a material that absorbs moisture.

12. An ultracapacitor module comprising
a housing defining multiple cell cavities within a single package;
a plurality of double-layer capacitor cells housed within each respective cell cavity;
a gas getter material disposed within the housing; and
a plurality of bars joining the cell cavities in series.

13. The ultracapacitor module of claim 12, wherein the module is hermetically sealed.

14. The ultracapacitor module of claim 12, wherein
each capacitor cell is formed as a roll of films and defines a hollow area in the center of the roll; and
the gas getter material is placed within the hollow area in each capacitor cell.

15. The ultracapacitor module of claim 12, wherein the gas getter material comprises a passivation layer resistant to moisture and atmospheric gases.

16. The ultracapacitor module of claim 12, wherein
the gas getter material is in the form of a powder; and
the ultracapacitor further comprises a gas permeable pouch containing the gas getter material.

17. A method making an ultracapacitor comprising inserting a gas getter material into a canister of the ultracapacitor.

18. The method of claim 17, wherein the inserting operation further comprises placing a composite the gas getter material into a void in a center of a jelly roll capacitor cell.

19. The method of claim 17, wherein the inserting operation further comprises placing a pouch of the gas getter material into a void in a center of a jelly roll capacitor cell.

20. The method of claim 17, wherein the inserting operation further comprises doping a negative electrode film within a capacitor cell with the gas getter material.

21. The method of claim 17 further comprising
forming a recess within a current collector; and
wherein the inserting operation further comprises filling the recess with the gas getter material.

22. The method of claim 17, wherein the inserting operation further comprises coating an interior surface of the canister with the gas getter material.
